(19) United States
(12) Patent Application Publication
(10) Pub. No.: US 2018/0051417 A1
(43) Pub. Date: Feb. 22, 2018

(54) METHOD OF MANUFACTURING PAPER WITH UNBLEACHED CELLULOSE PULP SUSPENSION CONTAINING ORGANIC RESIDUES

(71) Applicant: Solenis Technologies, L.P., Schaffhausen (CH)

(72) Inventors: John C. Harrington, Newark, DE (US); Bryan K. Spraul, Wilmington, NC (US); Jason E. Anderson, Elkton, MD (US)

(21) Appl. No.: 15/677,370

(22) Filed: Aug. 15, 2017

Related U.S. Application Data
(60) Provisional application No. 62/375,780, filed on Aug. 16, 2016.

(51) Int. Cl. D21H 17/45; D21H 21/10; D21H 17/68; D21J 1/08; C08F 122/38

(52) U.S. Cl. CPC D21H 17/455; D21H 21/10; C08F 122/38; D21J 1/08; D21H 17/68

(57) ABSTRACT

A method of making paper comprising adding to an aqueous suspension of cellulosic pulp slurry a polymer in the form of an inverse emulsion comprising a cationic poly N,N-(dialkylaminoalkyl) (meth)acrylamide or it's quaternates or salts, and dewatering the cellulose pulp slurry to form a paper or paperboard product, wherein the pulp slurry contains more than about 75 weight ppm of water soluble lignin based upon total pulp slurry weight, and wherein the polymer is added to the pulp slurry at a dosage of 0.001 to 1% by weight based upon cellulose pulp solids, and wherein the polymer optionally contains multi-functional monomer.

This application claims the benefit of provisional application number U.S. 62/375,780, filed Aug. 16, 2016, the entire contents of which are hereby incorporated by reference.

### FIELD OF INVENTION

The invention relates to a method of improving the dewatering properties of an unbleached cellulosic slurry containing organic residues from the pulping process.

### BACKGROUND

The process to manufacture paper and paperboard comprises depositing an aqueous slurry of cellulosic pulp on a moving papermaking wire or fabric, and forming a sheet from the solid components of the slurry by draining the water. This sheet is then pressed and dried to further remove water.

Papermakers continually strive to increase speed and productivity of the papermachine. Drainage or dewatering of the cellulose pulp slurry on the papermaking wire or fabric is often the limiting step in achieving faster paper machine speeds. Improved dewatering can also result in a drier sheet in the press and dryer sections, resulting in reduced energy consumption. Chemicals are often added to the fibrous slurry before it reaches the papermaking wire or fabric to improve drainage and dewatering; these chemicals are called drainage aids. Drainage aids are typically employed in the papermaking process to increase the drainage of the pulp and increase papermachine speed and productivity.

The manufacture of the cellulosic pulp slurry from wood requires many complex steps, including the formation of pulp fiber from wood chips. This process takes place in a digester, where wood chips are cooked at high temperature with, for example, sodium sulphide and sodium hydroxide, in order to break down and solubilize the lignin, so that it can be separated from the wood pulp. The most prominent by-product of the process is kraft lignin, a complex three-dimensional material based on repeating phenol propane units. Additional by-products include wood pitch, hemicelluloses, crude tall oil and turpentine. Following the digester, the black liquor (containing organics, mostly lignin, and inorganic spent cooking chemicals) is separated from the wood pulp in a process commonly known as brown stock washing. The washing of the kraft pulp in unbleached linerboard applications is not wholly efficient, and depending upon many process variables, a high level of organics and inorganics are generally present in the pulp slurry when it reaches the papermachine. The level of soluble organics and inorganics can vary greatly.

Conventional drainage aids have demonstrated reduced efficacy in furnish substrates which contain high levels of soluble organics and salts. Two such examples of these furnishes are kraft virgin linerboard and neutral sulfite semi-chemical (NSSC), where high levels of organic materials such as soluble lignin containing a high anionic charge are present. These highly anionic materials are believed to neutralize the charge on the conventional drainage aids, significantly reducing their effectiveness. Most of the kraft virgin containerboard and NSSC machines do not utilize a drainage aid because of the levels of organic materials interfering with the effectiveness of the drainage or dewatering.

U.S. Pat. No. 4,313,790 teaches a papermaking process by the addition of a high molecular weight non-ionic polyethylene oxide (PEO) in combination with a kraft lignin, which functions as a co-factor to promote the efficacy of the PEO. The non-ionic nature of the PEO is not affected by the soluble lignin and organics in the pulp furnish, and the soluble lignin in the kraft linerboard and NSSC applications actually functions as an inherent co-factor to promote the performance of the PEO. PEO has demonstrated a strong flocculation response in kraft linerboard and NSSC furnishes. However, as noted by Hubbe et. al. (BioResouces 2009, 4(2) 850-906) the high polymer MW PEO produces a relatively large floc which does not readily dewater, and can actually reduce the overall pulp dewatering.

U.S. Pat. Nos. 4,717,758, 5,115,065, and 5,698,627 teach a papermaking additive useful for papermaking in a neutral to alkaline pH region which comprises a water-soluble copolymer composed of up to 20 mole % of dimethylaminopropyl (meth)acrylamide or its quaternized product, and up to 98.9 mole % acrylamide.

U.S. Pat. No. 5,167,766 teaches a method of making paper which comprises adding to an aqueous paper furnish an ionic, organic, cross-linked polymeric microbead, the microbead having an unswollen particle diameter of less than about 750 nanometers and an ionicity of at least 1%. Dimethylaminopropylacrylamide is noted as one potential cationic monomer. All cationic microbeads were copolymers with acrylamide. The paper stocks are listed as “traditional chemical pulps, for instance, bleached and unbleached sulphate or sulphite pulp, mechanical pulp such as groundwood, thermomechanical or chemi-thermomechanical pulp or recycled pulp such as deinked waste and any mixtures thereof”; the presence of residual lignin and other organics in the pulp from the pulping process, and it's negative effect on the micro-bead performance, were not stated.

There remains a need to provide drainage in high lignin containing furnishes.

### DESCRIPTION OF INVENTION

Polymer comprising Poly (dialkylaminoalkyl (meth)acrylamide) and it's quaternates as an inverse emulsion has been identified as providing drainage in papermaking systems with high levels of residual organics, such as lignin. It has been found that these polymers have a greater tolerance to the soluble organics and lignin than conventional flocculants, and thus can function in applications with high levels of residual organics, such as lignin. Additionally, branched or cross-linked versions of the poly (dialkylaminoalkyl (meth)acrylamide) have demonstrated increased drainage performance as the level of soluble organics and lignin is increased.

It has been discovered that the addition of an inverse emulsion of poly(dialkylaminoalkyl (meth)acrylamide) or it's quaternates to a pulp slurry will improve papermachine drainage performance in an unbleached cellulosic furnish that contains high levels of organic and inorganic residues from the pulp mill, including water soluble lignin. The levels of water soluble lignin in the thin stock for these cellulosic furnishes range from 50 ppm up to 2500 weight ppm of lignin based upon total pulp slurry weight preferably from 75 ppm up to 2500 ppm. The total pulp slurry weight is defined as the total weight of the slurry, comprising water and cellulosic fibers. These polymers have demonstrated a greater tolerance to the organic residues such as lignin than conventional flocculants, and thus function in these applications. Additionally, cross-linked versions of the poly (dialkylaminoalkyl (meth)acrylamide) have demonstrated increased drainage performance as the level of organics and soluble lignin is increased.

The cellulosic pulp utilized in the process are unbleached systems which contain a high level of soluble organic and inorganic residues from the pulping process. The sources of the pulp are cellulose-based raw materials including, for example but without limitation, wood-based raw material softwoods like pine, spruce, cypress, fir, hemlock and cedar, and hardwoods including birch, elm, eucalyptus, oak, poplar, and maple; and plant-based raw materials like agricultural residue, grasses, straw, bark, cotton, maize, wheat, bagasse, bamboo, reed, algae, fungi and/or combinations thereof.

The pulping process used to obtain the pulp slurry has residual organics and inorganics present in the resultant pulp slurry. These pulping processes include but are not limited to chemical pulping such as kraft, sulfite and soda; mechanical processes including stone groundwood (SG), refiner mechanical pulp (RMP), pressurized groundwood (PG), and thermomechanical pulp (TMP); hybrid chemical—mechanical processes including neutral sulfite semi-chemical (NSSC) and chemithermomechanical pulp (CTMP); and combinations thereof.

The organic and inorganic residues from the pulping process can include excess cooking chemicals, spent cooking chemicals, resin acids, fatty acid, alkali lignin, hydroxy acids, lactones, sodium, acetic acid, formic acid, sulfur, extractives, methanol, lignosulfonate, monosaccharides (mannose, xylose, galactose, glucose and arabinose), poly and oligosaccharides, calcium, aldonic acids, sugar-sulfonates, extractives, and glucuronic acid.

The unbleached pulp after the washing stages is alkaline pH, ranging from 7-12 depending upon the brown stock washing process and efficiency. The pulp can then be diluted in consistency and refined to a target CSF (Canadian Standard Freeness) depending upon the desired final paper properties. More refining of the pulpl will result in increased printability, but requires more energy and is more difficult to dewater on the papermachine. The process pH at the headbox is acid to neutral; this reduction in pH from alkaline to neutral or acidic pH is accomplished by the addition of a mineral acid when the pulp is diluted to the thin stock consistency. An alumina source, generally aluminum sulfate (papermakers alum) can also be added at the thin stock dilution point to further reduce the pH.

The cellulosic slurry can also contain various process or functional additives, intended to improve the papermachine processing or to impart a specific property to the final formed sheet. These additives include sizing agents, starches, deposit control agents, mineral extenders, pigments, fillers, organic or inorganic coagulants, conventional flocculants, or other common additives to paper pulp. These additives can be naturally occurring, modified natural products, synthetic products, or mixtures thereof.

The formed sheet may be produced in a single ply, where one headbox is employed, or with multiple plies forming a composite sheet, where two or more headboxes are utilized.

The cationic polymer utilized in the invention is made from at least 50 mole %, or at least 70 mole % or preferably at least 90 mole % of cationic monomer, preferably greater than 95 percent by weight cationic monomer. The cationic polymer can be 100 mole % of one or more cationic monomers. The cationic polymer can be a homopolymer.

The polymer is a cationic polymer formed from the polymerization of one or more ethylenically unsaturated cationic monomers. The cationic monomers may include, for example but without limitation: N,N-dialkylaminoalkyl(meth)acrylamides, such as N,N-dimethylaminoethylacrylamide, N,N-dimethylaminoethylmethacrylamide, N,N-dimethylaminopropylacrylamide, N,N-dimethylaminopropylmethacrylamide, N,N-diethylaminoethylacrylamide, N,N-diethylaminoethylmethacrylamide, N,N-diethylaminopropylacrylamide, N,N-diethylaminopropylmethacrylamide and/or the salts and quaternaries thereof; and/or combinations thereof.

It is preferable that the polymer contain less than 10 mole % of non-ionic monomer, based upon total monomer or less than 5 mole %. The polymer can contain from 0 to 5 mole percent non-ionic monomer or from 0 to less than 10 mole % non-ionic monomer. It is preferable the resultant polymer is at least 90 mole % cationic monomer. Nonionic monomers can include, for example but without limitation, acrylamide; methacrylamide; N-alkylacrylamides, such as N-methylacrylamide; N,N-dialkylacrylamide, such as N,N-dimethylacrylamide; methyl acrylate; methyl methacrylate; acrylonitrile; N-vinyl methylacetamide; N-vinyl fromamide; N-vinyl methyl formamide; vinyl acetate; N-vinyl methyl formamide; vinyl acetate; N-vinyl pyrrolidone; hydroxyalky(meth)acrylates such as hydroxyethyl(meth)acrylate and/or hydroxypropyl(meth)-acrylate; and/or any combinations thereof.

Polymerization of the monomers may also occur with the use of a multi-functional monomer or agents to form a branched or crosslinked polymer. The multi-functional monomers contain two or more ethylenically unsaturated bonds. The multi-functional monomers can be either water or oil soluble. Examples of multi-functional monomers containing at least two double bonds include, but are not limited to: N,N-methylenebis(meth)acrylamide; polyethyleneglycol di(meth)acrylate; polypropyleneglycol di(meth)acrylate; polyethyleneglycol di(meth)acryamide; polypropyleneglycol di(meth)acrylamide; triallylommonium salts; trimethylolpropane tri(meth)acrylate; pentaerythritol tetra(meth)acrylate; N-methylallylacrylamide and the like. Multi-functional agents containing at least two reactive groups include dialdehydes, such as glyoxal; diepoxy compounds; epichlorohydrin and the like. The level of multi-functional monomer will range from 0.005 mole % to 0.1 mole % based upon total monomer or from 0.005 mole % to 0.05 mole % based upon total monomer or from 0.005 mole % to 0.03 mole % based upon total monomer.

The UL (ultra low) viscosity of polymers is utilized as a relative comparison of polymer hydrodynamic volume (HDV) in solution. The UL viscosity is measured utilizing a UL adapter (Brookfield Engineering, Middleboro, Mass.). The UL viscosity of a polymer is determined by dissolving a polymer or polymer emulsion in deionized water, then adding NaCl solution to give a polymer concentration of 0.5% and a NaCl concentration of 1.0 M, and measuring the viscosity of the polymer solution with a Brookfield LVT viscometer, using a #00 UL spindle at 25° C. If the solution viscosity is greater than 10 cps at 60 rpm, then the solution is measured at 30 rpm. The UL viscosity of the polymers decreases with the level of multi-functional monomer utilized in the polymer. The UL viscosity of the polymers used in the invention produced without any multi-functional monomers is between 2 and 25 cps, and preferably between 5 and 15. The UL viscosity of the polymers produced with multi-functional monomers is between 2 and 15 cps, and preferably between 1.2 and 5 cps.

The dynamic rheological properties of the inventive polymers are measured to characterize the level of mechanically active entanglements resulting from the level of multi-functional monomers. The G′ storage modulus increases with increased levels of multi-functional monomer. The rheological properties are determined with polymer solutions at 3.0% actives (w/w) in deionized water, utilizing a TA Instruments (New Castle, Del.) DHR-II controlled stress rheometer equipped with a 40 mm parallel plate at 25° C. A frequency sweep is conducted with the rheometer in dynamic oscillation mode, at a constant stress determined to be within the linear viscoelastic region, and a frequency range of 1 to 100 radians. The G′ storage modulus of the polymer solution is recorded at 40 radians per second. For the polymers used in the invention, the G′ storage modulus of the polymer solution is greater than 50 Pascals, and preferably greater than 75 Pascals.

The inverse (water-in-oil) emulsion polymerization process comprises: (1) preparing an aqueous solution of one or more ethylenically unsaturated cationic monomers (non-limiting examples of which are described above), (2) contacting the aqueous solution with a hydrocarbon liquid containing an appropriate emulsification surfactant or mixture of emulsification surfactants to form an inverse monomer emulsion, (3) subjecting the inverse monomer emulsion to free radical polymerization, and, optionally, (4) adding one or more breaker surfactants to enhance the inversion of the emulsion when added to water.

Polymerization of the emulsion may be carried out in any manner known to those skilled in the art. Initiation may be effected with a variety of thermal initiators including azo compounds such as 2,2′-azobis-(2,4-dimethylpentanenitrile) and azobisisobutyronitrile, organic peroxides such as dilauryl peroxide, and the like. Polymerization may also be initiated by “redox”, or reduction—oxidation pairs. These can include a number of oxidizers, typically organic peroxides such as dilauryl peroxide, cumene hydroperoxide, dicumyl peroxide and hydrogen peroxide. Reducing agents include sodium metabisulfite, and transition metals such as ferrous sulfate.

Preferred initiators are oil soluble thermal initiators. Typical non-limiting examples include 2,2′-azobis-(2,4-dimethylpentanenitrile); 2,2′- azobisisobutyronitrile (AlBN); 2,2′-azobis-(2,-methylbutanenitrile); 1,1′-azobis(cyclohexanecarbonitrile); benzoyl peroxide, and dilauryl peroxide.

Any of the chain transfer agents known to those skilled in the art may be used to control the molecular weight. Those include, for example but without limitation, lower alkyl alcohols such as isopropanol, amines, mercaptans such as mercaptoethanol, phosphites, thioacids, allyl alcohol, formic acid, and the like.

The aqueous phase may also comprise conventional additives as desired. For example, the mixture may contain chelating agents, pH adjusters, initiators, chain transfer agents as described above, and/or other conventional additives. The pH of the aqueous phase is in the range of from 2 to 7, preferably between 4 to 6.

The hydrocarbon liquid may comprise straight-chain hydrocarbons, branched-chain hydrocarbons, saturated cyclic hydrocarbons, aromatic hydrocarbons, and/or combinations thereof.

The emulsion surfactants used in the inverse (water-in-oil) emulsion polymerization process are generally known to those skilled in the art. Such surfactants typically have a range of Hydrophilic Lipophilic Balance (HLB) values that is dependent on the overall composition. The choice and amount of the emulsification surfactant(s) are selected in order to yield an inverse monomer emulsion for polymerization. One or more of the emulsion surfactants are selected in order to obtain a specific HLB value.

The emulsification surfactant or mixture of emulsification surfactants may comprise at least one diblock and/or triblock polymeric surfactant. The diblock and triblock polymeric surfactants can include, for example but without limitation: diblock and triblock copolymers based on polyester derivatives of fatty acids and poly[ethyleneoxide], such as Hypermer® B246SF available from Croda (New Castle, Del.); diblock and triblock copolymers based on polyisobutylene succinic anhydride and poly[ethyleneoxide]; reaction products of ethylene oxide and propylene oxide with ethylenediamine; and/or combinations thereof.

The emulsification surfactant or mixture of emulsification surfactants may also comprise for example but without limitation: sorbitan fatty acid esters, such as sorbitan monooleate commercially available from Croda (New Castle, Del.) under the brand name Atlas™ G-946; ethoxylated sorbitan fatty acid esters; polyethoxylated sorbitan fatty acid esters; ethylene oxide and/or propylene oxide adducts of alkylphenols; ethylene oxide and/or propylene oxide adducts of long chain alcohols or fatty acids; mixed ethylene oxide/propylene oxide block copolymers; alkanolamides; sulfosuccinates; and combinations thereof.

Breaker surfactants are additional surfactants that can be added to an emulsion to promote inversion when the emulsion is added to water at a concentration typically 0.25 to 3% of emulsion based upon emulsion product. The breaker surfactants can include, for example but without limitation, ethylene oxide (EO)/propylene oxide (PO) diblock (AB) and triblock (ABA or BAB) copolymers, ethoxylated alcohols, alcohol ethoxylates, ethoxylated esters of sorbitan, ethoxylated esters of fatty acids, ethoxylated fatty acid esters and ethoxylated esters of sorbitol and fatty acids or combination of any of the preceding.

The cationic polymer may be added to the pulp slurry at any amount that is effective in achieving flocculation. In one embodiment, the amount of polymer(s), as described above, may be added to the cellulose pulp slurry at an amount greater than 0.05 lbs. of polymer(s) per ton of dry cellulose pulp solids, or from about 0.02 to 4 lbs. of polymer(s) per ton of dry cellulose pulp solids, or more preferably 0.05 to 2 lbs of polymer per ton of cellulose pulp solids.

The cationic polymer may be added to a pulp slurry prior to and/or while in the wet end of a paper machine to increase the drainage performance of the pulp slurry during the papermaking process. Generally, retention and drainage aids are added to the pulp slurry close to the forming section of a paper machine where the pulp slurry is known as “thin stock.” Typical addition points to the pulp slurry include feed point(s) before the fan pump, after the fan pump, before the pressure screen, and/or after the pressure screen. The cationic polymer may also be added to the “thick stock” before dilution to the thin stock; additions points include the stuff box, machine chest, blend chest, and the like.

The cationic polymer may also be employed with an inorganic siliceous material. The siliceous material may be any of the materials selected from the group consisting of silica based particles, silica microgels, colloidal silica, silica sols, silica gels, polysilicates, cationic silica, aluminosilicates, polyaluminosilicates, borosilicates, polyborosilicates, zeolites and swelling clays. When the siliceous material is a swelling clay it may typically a bentonite type clay. The preferred clays are swellable in water and include clays which are naturally water swellable or clays which can be modified, for instance by ion exchange to render them water swellable. Suitable water swellable clays include but are not limited to clays often referred to as hectorite, smectites, montmorillonites, nontronites, saponite, sauconite, hormites, attapulgites and sepiolites. The siliceous material is applied in an amount between 50 ppm (by weight/weight) and 10,000 weight ppm based on weight of cellulose pulp solids, or more preferred doses of 100 ppm to 2000 weight ppm based on cellulose pulp solids.

The invention provides for a method of making paper comprising adding to an aqueous suspension of cellulosic pulp slurry a polymer in the form of an inverse emulsion comprising a cationic poly N,N-(dialkylaminoalkyl) (meth)acrylamide or it's quaternates or salts; and dewatering the cellulose pulp slurry to form a paper or paperboard product, wherein the pulp slurry contains more than about 50 and preferably more than 75 weight ppm of water-soluble lignin based upon total pulp slurry weight. The polymer can be added to the pulp slurry at a dosage of 0.001 to 1% by weight based upon cellulose pulp solids or at a dosage of 0.01 to 1% by weight. The polymer can have a 0.5% active UL viscosity of less than 15.0 cps or less than 10 cps.

The invention also provides for a method of making paper comprising adding to an aqueous suspension of cellulosic pulp slurry a polymer in the form of an inverse emulsion comprising a cationic poly N,N-(dialkylaminoalkyl) (meth)acrylamide or it's quaternates or salts, and dewatering the cellulose pulp slurry to form a paper or paperboard product, wherein the pulp slurry contains more than about 50 and preferably more than 75 weight ppm of water soluble lignin based upon total pulp slurry weight, The polymer can be added to the pulp slurry at a dosage of 0.001 to 1% by weight based upon cellulose pulp solids or at a dosage of 0.01 to 1% by weight. The polymer can contain greater than about 25 molar ppm of multi-functional monomer based upon total monomer. The polymer can have a G′ storage modulus of a 3% active polymer solution at a frequency of 40 rads/s of greater than 75 Pa, and a 0.5% active UL viscosity of less than 15.0 cps or less than 10.

The method of any of the preceding inventions wherein the cellulosic pulp slurry is unbleached.

The method of any of the preceding inventions wherein the pulp slurry contains more than about 100 weight ppm of water soluble lignin based upon total pulp slurry weight.

The method of any of the preceding inventions wherein the cationic poly N,N-(dialkylaminoalkyl) (meth)acrylamide or it's quaternates comprises greater than 90% cationic monomer.

The method of any of the preceding inventions wherein the cationic poly N,N-(dialkylaminoalkyl) (meth)acrylamide and/or it's quaternates comprises greater than 95% cationic monomer.

The method of any of the preceding inventions wherein the cationic poly N,N-(dialkylaminoalkyl) (meth)acrylamide or it's quaternates is selected from the group consisting of N,N-dimethylaminoethylacrylamide, N,N-dimethylaminoethylmethacrylamide, N,N-dimethylaminopropylacrylamide, N,N-dimethylaminopropylmethacrylamide, N,N-diethylaminoethylacrylamide, N,N-diethylaminoethylmethacrylamide, N,N-diethylaminopropylacrylamide, N,N-diethylaminopropylmethacrylamide and the salts and quaternaries thereof; and/or combinations thereof.

The method of any of the preceding inventions wherein the cationic poly N,N-(dialkylaminoalkyl) (meth)acrylamide comprises N,N-dimethylaminopropylacrylamide or it's quaternates.

The method of any of the preceding inventions wherein the cationic polymer further comprises a nonionic monomer selected from the group consisting of acrylamide; methacrylamide; N-alkylacrylam ides, N,N-dialkylacrylamide, methyl acrylate; methyl methacrylate; acrylonitrile; N-vinyl methylacetamide; N-vinyl fromamide; N-vinyl methyl formamide; vinyl acetate; N-vinyl methyl formamide; vinyl acetate; N-vinyl pyrrolidone; hydroxyalky(meth)acrylates; and combinations thereof.

The method of any of the preceding inventions wherein the polymer comprises less than 10 mole % of non-ionic monomer, based upon total monomer, wherein the resultant polymer contains at least 90 mole % cationic monomer.

The method of any of the preceding inventions wherein the polymer comprises less than 5 mole % of non-ionic monomer, based upon total monomer, wherein the resultant polymer contains at least 95 mole % cationic monomer.

The method of any of the preceding inventions wherein the polymer further comprises multifunctional monomer.

The method of any of the preceding inventions wherein the polymer is added to the pulp slurry at a dosage of 0.01 to 1% by weight based upon the weight of cellulose pulp solids.

The method of any of the preceding inventions wherein the polymer has a 0.5% active UL viscosity of less than 10.0 cps.

The method of any of the preceding inventions further comprising adding a siliceous material.

The method of any of the preceding inventions wherein the siliceous material is selected from the group consisting of silica based particles, silica microgels, amorphous silica, colloidal silica, anionic colloidal silica, silica sols, silica gels, polysilicates, polysilicic acid, and combinations thereof.

The method of any of the preceding inventions wherein the polymer contains between 50 and 500 molar ppm of multi-functional monomer based upon total monomer.

The method of any of the proceeding inventions wherein at least one additional coagulant or flocculant is added to the pulp slurry. The one additional coagulant or flocculant can be water soluble.

The method of any of the proceeding inventions where the cellulosic pulp slurry has less than 5% by weight filler based on weight of the cellulose pulp solids. An example of filler is kaolin clay or titanium dioxide.

### EXAMPLES

The following examples show one method of making a cationic polymer using the inverse (water-in-oil) emulsion polymerization process. Additionally, the following examples illustrate the increased drainage performance of an unbleached pulp slurry containing organic and inorganic pulp mill residues resulting from adding at least one substantially cationic polymer to the pulp slurry. These examples are merely illustrative of the presently disclosed and/or claimed inventive concept(s) and are not to be construed as limiting the presently disclosed and/or claimed inventive concept(s) to the particular compounds, processes, conditions, or applications disclosed therein.

Examples 1-10. A sample of the polymer was prepared as described. An oil phase of paraffin oil (140 g, Conosol™ C170 oil, available from Calumet Specialty Products, Karns City, Pa.) and emulsification surfactants (15 g Hypermer™ 1031, Croda, New Castle, Del.) were charged to a suitable glass vacuum reaction flask equipped with an overhead 4 blade mechanical stirrer, heating mantle, thermometer, nitrogen sparge tube, vacuum pump, regulator, and distillate trap.

An aqueous phase was prepared separately which comprised 60 wt % dimethylaminopropyl acrylamide chloride solution in water (333.3 g), deionized water (61.16 g), and Versenex™ 80 (Dow Chemical) chelant solution (0.18 g). The aqueous phase was then adjusted to pH 5.0 with the addition of approximately 1.2 grams of concentrated sulfuric acid.

The aqueous phase was then charged to the oil phase at ambient temperature while being mixed with the mechanical stirrer, the emulsion was then mixed for an additional 10 minutes. Next, the mixture was homogenized with a Braun hand-held mixer for 30 seconds to obtain a stable water-in-oil emulsion. This emulsion was sparged with nitrogen for 60 minutes, while the temperature of the emulsion was increased to 61° C. The emulsion was continuously mixed during the process. Afterwards, the sparge was discontinued, the reactor was sealed, and a vacuum was applied to a level of 125 torr and water was distilled off to reduce the reactor temperature of 57° C.

The polymerization was initiated by adding 5 mls of a 1.5% solution of 2,2′-azobis-(2,4-dimethylpentanenitrile) (V-65, Wako Chemicals, Richmond, Va.) in Conosol C170 oil, corresponding to 300 molar ppm of initiator based upon total moles of monomer. The reaction commenced as evidenced by an increase in temperature to 58° C. and the generation of distillate water. The reaction continued until the temperature decreased to 55° C. The vacuum was removed, a nitrogen sparge was applied, and the reaction was heated to 75° C. with the use of an external heating mantle. The reaction was then cooled to 45° C., and 0.61 grams of a 30% aqueous solution of sodium metabisulfite (Sigma Aldrich, Milwaukee, Wis.) was added. The batch was the cooled and a breaker surfactant comprising 10 grams of Genapol LA 070S (Clariant, Charlotte, N.C.) was added.

These acronyms will be utilized in the following examples:
DIMAPA—dimethylaminopropyl acrylamide
DIMAPA-Q—dimethylaminopropyl acrylamide chloride
DIMAPMA-Q—dimethylaminopropyl methacrylamide chloride
ADAME-Q—2-dimethylamino ethylacrylate chloride
AM—acrylamide
MBA—methylenebisacrylamide
MFM—multi-functional monomer
Additional examples and comparative examples were prepared according to Example 1 with the following modifications:

TABLE 1

| | | Monomer | | MFM Molar | UL viscosity, | G' Storage Modulus, |
|---|---|---|---|---|---|---|
| Polymer | Monomer | Ratios | MFM | ppm | 0.5%, cps | 3% active, Pa |
| Example 1 | DIMAPA-Q | 100 | | | 9.1 | 32.5 |
| Example 2 | DIMAPA | 100 | MBA | 0.02 | 2.08 | |
| Example 3 | DIMAPA | 100 | MBA | 0.05 | 1.68 | |
| Example 4 | DIMAPA-Q | 100 | MBA | 0.02 | 4.33 | 102.8 |
| Example 5 | DIMAPA-Q | 100 | MBA | 0.05 | 2.24 | 639.6 |
| Example 6 | DIMAPA-Q | 100 | MBA | 0.1 | 1.76 | 1190.6 |
| Example 7 | DIMAPA-Q | 100 | MBA | 0.005 | 14 | |
| Example 8 | DIMAPA-Q | 100 | MBA | 0.01 | 10 | |
| Example 9 | DIMAPMA-Q | 100 | — | — | 6.69 | |
| Example 10 | DIMAPMA-Q | 100 | MBA | 0.02 | 2.54 | |
| Comparative Example 1 | ADAME-Q/AM | 10/90 | MBA | 0.05 | 1.49 | |
| Comparative Example 2 | ADAME-Q/AM | 10/90 | MBA | 0.1 | 1.39 | |

MFM—multifunctional monomer
MFM Molar ppm—molar ppm of MFM based upon total moles of monomer

A series of drainage tests were conducted to evaluate the performance of the polymer samples from Table 1. A thick stock machine chest pulp sample from a US southern virgin linerboard manufacturer was utilized to prepare a test furnish in a series of drainage tests; the data are provided below in Tables 2, 3, and 4. The thick stock consistency was in the range of 3.6 weight % and the pH was in the range of 9-10. The consistency was diluted to 0.8%, the pH was adjusted to 5.0 with concentrated sulfuric acid, 0.15% sodium sulfate was added to achieve a total conductivity of 2500 μS/cm, and Indulin C (Mead Westvaco, North Charleston, S.C.) was added to achieve a total water soluble lignin level of 349 weight ppm based on total pulp slurry weight. The level of water soluble lignin in all subsequent examples are weight ppm based upon total pulp slurry weight. The drainage activity of the invention was determined utilizing a Dynamic Drainage Analyzer (“DDA”), test equipment available from AB Akribi Kemikonsulter, Sundsvall, Sweden. The test device applies a 300 mbar vacuum to the bottom of the separation medium. The device electronically measures the time between the application of vacuum and the vacuum break point, i.e. the time at which the air/water interface passes through the thickening fiber mat. It reports this value as the drainage time. A lower drainage time is preferred. 500 mls of stock is added to the DDA and the drainage test is conducted at a total instrument vacuum of 300 mbar pressure.

The level of soluble lignin was determined by measuring the absorbance of a filtered furnish sample at a wavelength of 280 nm using an Ocean Optics (Dunedin, Fla.) USB 4000 spectrometer. The quantitative level of lignin was determined from a calibration curve, derived by measuring the absorbance at 280 nm of a series of Indulin C kraft lignin at varying concentrations ranging from 50 to 1000 weight ppm.

The treatment dosages in all experiments were 15 pounds per ton aluminum sulfate dodecahydrate (Delta Chemical, Baltimore, Md.), then followed by one of the following drainage aid treatments from Table 1. This series of experiments also utilized a commercial drainage aid Hercobond® 6950 (Solenis, Wilmington, Del.) a modified polyvinylamine. Ten seconds mix time was utilized between additives, and after the last additive before commencing the drainage test. The dosages are all polymer product based upon dry pulp. The reported drainage times are the average of 3 test replicates.

TABLE 2

| | | Drain | |
|---|---|---|---|
| | #/T | Time, | % |
| Polymer | (active) | s | Change |
| None | 0 | 9.53 | 0 |
| Example 1 | 2 | 7.67 | 19.50 |
| Example 2 | 2 | 7.34 | 22.96 |
| Example 3 | 2 | 7.62 | 19.99 |
| Comparative Example 1 | 2 | 8.57 | 10.09 |
| Comparative Example 2 | 2 | 9.08 | 4.67 |
| Hercobond 6950 | 2 | 10.20 | −7.00 |

TABLE 3

| | #/T | Drain | % |
|---|---|---|---|
| Polymer | (active) | Time, s | Change |
| None | 0 | 7.84 | |
| Example 1 | 2 | 7.44 | 5.10 |
| Example 2 | 2 | 7.03 | 10.29 |
| Example 3 | 2 | 7.24 | 7.56 |
| Example 4 | 2 | 6.41 | 18.24 |
| Example 5 | 2 | 6.85 | 12.63 |

TABLE 4

| | #/T | Drain | % |
|---|---|---|---|
| Polymer | (active) | Time, s | Change |
| None | 0 | 7.77 | 0 |
| Example 2 | 2 | 6.43 | 17.20 |
| Example 3 | 2 | 6.78 | 12.78 |
| Example 6 | 2 | 6.46 | 16.82 |
| Comparative Example 1 | 2 | 7.17 | 7.72 |
| Comparative Example 2 | 2 | 6.79 | 12.57 |

The data demonstrate better (lower drainage times) drainage provided by the inventive polymer compared to conventional ADAM-E/AM drainage aid polymers. The commercial drainage aid Hercobond 6950 product was not effective in this high lignin environment. An improvement is also noted with Examples 2, 4, 5, and 6 compared to Example 1 when modified with multi-functional monomer MBA.

Another series of experiments was conducted to illustrate the negative effect of soluble lignin on the performance of conventional drainage aids. The same thick stock in the above examples was utilized, but was washed repeatedly with deionized water to remove the soluble lignin from the pulp slurry. A fabric comprising 200 thread count was utilized so no fiber fines were removed from the pulp slurry. The furnish was then prepared as above, but no lignin was added initially. The soluble lignin was measured at 30 weight ppm. A first series of drainage studies were conducted, then the stock was modified by the addition of 270 weight ppm of Indulin AT (Mead Westvaco, North Charleston, S.C.) for a total soluble lignin content of 300 weight ppm. The data in Table 5 illustrate the positive drainage response from the commercial drainage aid Hercobond 6950 in the low lignin substrate. The drainage of the commercial product was negatively affected by the increase of lignin from 30 to 300 weight ppm. This was also evident in Table 2, where the Hercobond 6950 was ineffective in the furnish containing 350 weight ppm of water soluble lignin.

TABLE 5

| | | | Drain | |
|---|---|---|---|---|
| | #/T | Lignin, | Time, | % |
| Polymer | (active) | ppm | s | Change |
| None | 0 | 30 | 2.92 | |
| Hercobond 6950 | 2 | 30 | 2.50 | 14.40 |
| None | 0 | 300 | 3.28 | |
| Hercobond 6950 | 2 | 300 | 3.53 | −7.61 |

Another series of drainage studies were conducted utilizing stock from a second US southern virgin linerboard manufacturer. Samples of refined machine chest thick stock and tray water were utilized to prepare a test furnish to replicate the actual papermachine conditions. The final consistency was 0.4%, the pH was 5.2, the conductivity was 3250 μS/cm, and the water soluble lignin was 99 weight ppm. The same drainage methods for the DDA in the previous samples were utilized. This series of experiments was conducted with 9 pounds of alum per ton of dry furnish pulp. The data are presented in Table 6, and demonstrate good drainage performance from the inventive polymers.

TABLE 6

| | #/T | Drain | % |
|---|---|---|---|
| Polymer | (active) | Time, s | Change |
| None | 0 | 12.39 | |
| Example 1 | 1 | 10.26 | 17.20 |
| Example 4 | 1 | 11.84 | 4.39 |
| Example 5 | 1 | 11.54 | 6.86 |
| Example 7 | 1 | 11.49 | 7.21 |

Another series of drainage studies were conducted utilizing stock from a third US southern virgin linerboard manufacturer. Samples of refined machine chest thick stock and tray water were utilized to prepare a test furnish to replicate the actual papermachine conditions. The final consistency was 0.6%, the pH was 5.0, the conductivity was 2250 μS/cm, and the soluble lignin was 30 weight ppm. The same drainage methods for the DDA in the previous samples were utilized. This series of experiments was conducted with 18 pounds per ton of alum. This series of experiments also utilized a commercial drainage aid Hercobond® 6950 (Solenis, Wilmington, Del.) a modified polyvinylamine. The data are presented in Table 7, and demonstrate good drainage performance from the inventive polymers compared to the commercial drainage aid, which did not provide a drainage response above the untreated system.

TABLE 7

| | #/T | Drain | % |
|---|---|---|---|
| Polymer | (active) | Time, s | Change |
| None | 0 | 16.19 | |
| Example 1 | 1 | 14.85 | 8.26 |
| Example 4 | 1 | 15.79 | 2.49 |
| Example 5 | 1 | 16.98 | −4.85 |
| Example 7 | 1 | 15.11 | 6.67 |
| Example 8 | 1 | 15.64 | 3.40 |
| HercoBond 6950 | 2 | 16.04 | 0.93 |

Another series of drainage studies were conducted utilizing stock from a fourth US southern virgin linerboard manufacturer. Samples of refined machine chest thick stock and tray water were utilized to prepare a test furnish to replicate the actual papermachine conditions. The final consistency was 0.6%, the pH was 4.2, the conductivity was 3050 μS/cm, the water soluble lignin was 325 weight ppm. The same drainage methods for the DDA in the previous samples were utilized. This series of experiments was conducted with 19 pounds per ton of alum. The polymer dosages are based upon an as received polymer basis. The data are presented in Table 8, and a positive drainage response was provided from polymer Examples 1 and 4 compared to the untreated system.

TABLE 8

| | #/T (as | Drain | % |
|---|---|---|---|
| Polymer | product) | Time, s | Change |
| None | | 21.0 | 0 |
| Example 1 | 1 | 14.0 | 33.3 |
| Example 1 | 2 | 12.3 | 41.4 |
| Example 4 | 1 | 19.0 | 9.5 |
| Example 4 | 2 | 19.0 | 9.5 |

Another series of drainage studies were conducted utilizing stock from the third US southern virgin linerboard manufacturer (Table 7), where the effect of lignin concentration on the drainage of the inventive polymers was evaluated. The level of lignin in the furnish was initially 30 weight ppm, and was increased by the addition of the noted level of kraft lignin (Indulin C, Mead Westvaco, North Charleston, S.C.) or lignosulfonate (Borrosperse NA, LignoTech USA, Bridgewater, N.J.). Samples of refined machine chest thick stock and tray water were utilized to prepare a test furnish to replicate the actual papermachine conditions. The initial consistency was 0.4%, the pH was 5.0, the conductivity was 2320 μS/cm. After each addition of lignin, the pH was adjusted to 5.0. The same drainage methods for the DDA in the previous samples were utilized. This series of experiments was conducted with 18 pounds per ton of alum. The data are presented in Table 9. The drainage of Example 4 modified with 200 molar ppm of MBA based upon total monomer becomes faster than the control. Example 4 maintains a positive drainage response upon the addition of lingo-sulfonate, a highly anionic lignin.

TABLE 9

| | | Kraft | Ligno- | | |
|---|---|---|---|---|---|
| | #T | Lignin, | sulfonate, | Drain | % |
| Polymer | (active) | ppm | ppm | time | Change |
| None | 0 | 30 | 0 | 13.1 | 0.0 |
| Example 4 | 1 | 30 | 0 | 13.0 | 0.7 |
| None | 0 | 130 | 0 | 14.8 | 0.0 |
| Example 4 | 1 | 130 | 0 | 13.2 | 10.7 |
| None | 0 | 330 | 0 | 19.0 | 0.0 |
| Example 4 | 1 | 330 | 0 | 17.7 | 6.8 |
| None | 0 | 330 | 100 | 13.4 | 0.0 |
| Example 4 | 1 | 330 | 100 | 12.9 | 3.8 |

Another series of drainage studies were conducted utilizing the modified stock from the first US southern virgin linerboard manufacturer (Tables 2, 3, and 4). In this series of experiments homo-polymers of dimethylaminopropyl methacrylamide chloride were utilized. The data are presented in Table 10, and illustrate a positive drainage response using linear and cross-linked polymers prepared with this monomer.

TABLE 10

| | #/T | Drain | % |
|---|---|---|---|
| Polymer | (active) | Time, s | Change |
| None | 0 | 8.79 | |
| Example 9 | 1 | 8.33 | 5.20 |
| Example 10 | 1 | 7.43 | 15.44 |

1. A method of making paper comprising adding to an aqueous suspension of cellulosic pulp slurry a polymer in the form of an inverse emulsion comprising a cationic poly N,N-(dialkylaminoalkyl) (meth)acrylamide or it's quaternates or salts; and dewatering the cellulose pulp slurry to form a paper or paperboard product, wherein the pulp slurry contains more than about 75 weight ppm of water-soluble lignin based upon total pulp slurry weight.

2. The method of claim 1 wherein the polymer further comprises multifunctional monomer.

3. The method of claim 2, wherein the polymer contains greater than about 25 molar ppm of multi-functional monomer based upon total monomer, and wherein the polymer has a G′ storage modulus of a 3% active polymer solution at a frequency of 40 rads/s of greater than 75 Pa.

4. The method of claim 2, wherein the polymer contains between 50 and 500 molar ppm of multi-functional monomer based upon total monomer.

5. The method of claim 1, wherein the cellulosic pulp slurry is unbleached.

6. The method of claim 1 wherein the pulp slurry contains more than about 100 weight ppm of water soluble lignin based upon total pulp slurry weight.

7. The method of claim 1 wherein the polymer comprises greater than 90% cationic monomer.

8. The method of claim 1 wherein the cationic poly N,N-(dialkylaminoalkyl) (meth)acrylamide or it's quaternates or its salts is formed from the polymerization of one or more cationic monomers wherein at least one cationic monomer is selected from the group consisting of N,N-dimethylaminoethylacrylamide, N,N-dimethylaminoethylmethacrylamide, N,N-dimethylaminopropylacrylamide, N,N-dimethylaminopropylmethacrylamide, N,N-diethylaminoethylacrylamide, N,N-diethylaminoethylmethacrylamide, N,N-diethylaminopropylacrylamide, N,N-diethylaminopropylmethacrylamide and the salts and quaternaries thereof; and/or combinations thereof.

9. The method of claim 1 wherein the cationic poly N,N-(dialkylaminoalkyl) (meth)acrylamide comprises N,N-dimethylaminopropylacrylamide or it's quaternates or its salts.

10. The method of claim 1 wherein the polymer further comprises a nonionic monomer selected from the group consisting of acrylamide; methacrylamide; N-alkylacrylamides, N,N-dialkylacrylamide, methyl acrylate; methyl methacrylate; acrylonitrile; N-vinyl methylacetamide; N-vinyl fromamide; N-vinyl methyl formamide; vinyl acetate; N-vinyl methyl formamide; vinyl acetate; N-vinyl pyrrolidone; hydroxyalky(meth)acrylates; and combinations thereof.

11. The method of claim 1 wherein the polymer comprises less than 10 mole % of non-ionic monomer, based upon total monomer, and wherein the resultant polymer contains more than 90 mole % cationic monomer.

12. The method of claim 1 wherein the polymer comprises less than 5 mole % of non-ionic monomer, based upon total monomer, wherein the resultant polymer contains more than 95 mole % cationic monomer.

13. The method of claim 1 wherein the polymer is added to the pulp slurry at a dosage of 0.001 to 1% by weight based upon cellulose pulp solids.

14. The method of claim 1 wherein the polymer has a 0.5% active UL viscosity of less than 15.0 cps.

15. The method of claim 1 wherein the polymer has a 0.5% active UL viscosity of less than 10.0 cps.

16. The method of claim 1 further comprising adding a siliceous material to the cellulosic pulp slurry.

17. The method of claim 16 wherein the siliceous material is selected from the group consisting of silica based particles, silica microgels, amorphous silica, colloidal silica, anionic colloidal silica, silica sols, silica gels, polysilicates, polysilicic acid, and combinations thereof.

18. The method of claim 1 wherein at least one additional coagulant or flocculant is added to the pulp slurry.

19. The method of claim 18 wherein the one additional coagulant or flocculant is water soluble.

20. The method of claim 1 wherein the cellulosic pulp slurry has less than 5% by weight filler based on weight of the cellulose pulp solids.
